(19) United States
(12) Patent Application Publication
(10) Pub. No.: US 2025/0201132 A1
(43) Pub. Date: Jun. 19, 2025

(54) DEVICE AND METHOD FOR MANAGING ENERGY FOR DESCENT AND APPROACH PHASES OF AN AIRCRAFT

(71) Applicant: THALES, MEUDON (FR)

(72) Inventors: Johan BOYER, TOULOUSE (FR); Geoffrey DURAND, TOULOUSE (FR); Pascal RIVES, TOULOUSE (FR)

(21) Appl. No.: 18/960,451

(22) Filed: Nov. 26, 2024

(30) Foreign Application Priority Data
Dec. 13, 2023 (FR) 2314070

(51) Int. Cl. G08G 5/32; G08G 5/21; G08G 5/54

(52) U.S. Cl. CPC G08G 5/32; G08G 5/21; G08G 5/54

(57) ABSTRACT

A method for establishing, for descent and approach phases of an aircraft, an efficient energy-dissipation strategy is provided, taking the form of a computation of an optimized descent and approach path, which aims to maximize employment of the idle regime while minimizing use of air brakes via more efficient deceleration.

### CROSS-REFERENCE TO RELATED APPLICATION

This application claims priority to foreign French patent application No. FR 2314070, filed on Dec. 13, 2023, the disclosure of which is incorporated by reference in its entirety.

### FIELD OF THE INVENTION

The present invention relates to the field of flight management and more specifically relates to a method for managing the energy of an aircraft during descent and approach phases.

### BACKGROUND

Flight management systems (FMS) offer pilots help during flight by providing information on piloting, navigation, estimates, fuel consumption, etc.

There are various flight management systems the capacities and the functionalities of which may vary greatly depending on the aircraft (helicopter, airliner, etc.), its uses (civil, military, etc.) and other factors (date of design especially).

The functionalities or services available on an FMS 100 are provided by various components (illustrated in FIG. 1) and generally comprise a flight plan 110; a lateral trajectory 120; a navigation database 130; predictions 140; a performance database 150; guidance 160; a location 170; a digital data link 180. The pilot has at her or his disposition a human-machine interfaces (HMI) enabling her or him to manage a flight plan, before departure and during navigation.

The “flight plan” module or FPLN 110 allows geographical elements providing the bare bones of the route to be followed (departure and arrival procedures, waypoints, airways).

The lateral trajectory module, or TRAJ 120, makes it possible to construct a continuous path from the points of the flight plan, while respecting the capabilities of the aeroplane and meeting containment constraints (RNP).

The navigation database, or NAVDB 130, contains the information required to construct geographical routes and procedures from the data contained in the databases (i.e. waypoints, beacons, intercept or altitude segments or legs, etc.).

The prediction module, or PRED 140, makes it possible to construct an optimized vertical profile on a lateral trajectory.

The performance database, or PERF DB 150, contains aerodynamic and engine parameters of the aircraft.

The guidance module, or GUID 160, allows the aircraft to be guided in lateral and vertical planes on its 4D path, while optimizing speed.

The location module, or “Navigation LOC NAV” 170, makes it possible to achieve optimal location of the aircraft using various sources of radio navigation data, delivered by positioning systems and sensors, such as GPS, GALILEO, VHF radio beacons, and inertial measurement units.

The digital datalink module, or DATALINK 180, makes it possible to communicate with control centres and other aircraft.

Based on a flight plan, the FMS is able to compute a reference path to follow, which is displayed on display screens, with an estimate of a set of data liable to be useful to the pilot during the flight, such as the times at which the various way points of the flight plan will be reached, an estimate of the amount of fuel on board, etc. The results of the computations performed by a computer of the FMS and the flight information are generally rendered on display systems coupled to the FMS, in order to convert the data into readable information.

Thus, the FMS is able to control the entirety of a flight, from take-off to landing, all the required computations being performed by a flight management computer (FMC).

To land the aircraft, an arrival procedure is selected (default approach strategy in the FMS or strategy chosen by the pilot), and during the descent and approach phases, the FMS allows a speed and altitude profile that is optimized in respect of aircraft performance to be computed, which profile meets all the constraints contained in the selected arrival procedure, while passing laterally through all the waypoints defined in the flight plan.

Standards regulate the way in which flight profiles are computed in the arrival phase. Although a detailed description of the computation of typical descent and approach profiles is not given in the present document, such information should be considered to form part of the general knowledge of those skilled in the art. Examples are given in FIGS. 4a-4f in patent application FR3012630, which also belongs to the Applicant, and the content of which is incorporated herein in its entirety by reference.

In summary, it is tolerated to compute an energy-dissipation strategy provided that guarantees are provided on vertical excursions, and that they are contained in an acceptable space.

The path thus obtained is a reference that ensures that the aircraft, if automatic control to this computed profile is achieved, reaches an energetic state suitable for landing.

So-called CDA flight procedures (CDA standing for Continuous Descent Approach) are intended to cause an aircraft to descend towards a runway with reduced engine thrust in order to minimize the sound pollution and low-altitude pollution.

Currently, pilots seek to carry out the descent as long as possible in an idle regime known as “idle thrust” or “idle”, over a portion located between the cruising end point where descent begins, which point is commonly designated the “top of descent” or “ToD”, and a point as close as possible to the runway, after which reduced thrust may no longer be maintained. The length of this segment in idle mode depends on altitude and speed constraints and/or time constraints that are defined in the descent procedures.

Generally, the altitude, slope, speed or time constraints at waypoints or of the flight plan may be expressed in various ways. The altitude constraints may be “AT” constraints (passage through the point at the given altitude) “AT OR ABOVE” constraints (passage at or above the given altitude) “AT OR BELOW” constraints (passage at or below the altitude) or “WINDOW” constraints (passage between two altitudes). The speed constraints may be “AT” constraints (passage through the point at the given speed) “AT OR ABOVE” constraints (passage at or above the given speed) or “AT OR BELOW” constraints (passage at or below the speed). The time constraints may be “AT” constraints (passage through the point at the given time), “AT OR AFTER” constraints (passage at or after the given time), “AT OR BEFORE” constraints (passage at or before the given time) or “WINDOW” constraints (passage between two times).

So-called “green” flight procedures, which aim, among other things, to reduce noise and fuel consumption, consist in flying the aircraft as high as possible with respect to the dwellings, while maximizing portions at reduced thrust. The decrease in noise is thus achieved by increasing the altitude of the reference profile and by reducing “engine” noise, and it is thus necessary to descend with thrust idle for as long as possible. It is thus necessary to avoid segments the slopes of which require thrust to be applied to maintain plane and speed.

Maintaining the idle regime for as long as possible mechanistically decreases emission of pollutants because it is the regime that consumes the least fuel. This decrease in fuel consumption also meets objectives in respect of reducing airline running costs.

Lastly, operationally, crews need to control dissipation of total aircraft energy during descent, i.e. to control decelerations and altitude losses to reach, with an energy compatible with landing, the start of the final segment, i.e. a segment aligned with the runway, generally with a slope close to −3°, which is often materialized by an electromagnetic glide-slope beam.

A general technical problem with current flight management systems is that they do not allow the decelerations and altitude losses required by such procedures to be concatenated in an efficient manner.

Specifically, the strategy conventionally applied by prior-art FMSs for descents in CDA mode is to fly on a geometric slope between the various procedural altitude constraints.

However, the geometric slope is suboptimal both for constant-speed segments and for decelerated segments.

Specifically, decelerations are generally not at all or not very efficient on segments of constant slope between two constraining altitude constraints (i.e. imperative constraints that must be met by the aircraft).

Generally, the following operational drawbacks result:
excess fuel consumption on constant-speed segments, leading to excessive CO2 emissions;
increased and excessive use of air brakes on decelerated segments, resulting in cabin discomfort, noise and workload for the crew;
excessively long decelerations with deceleration rates that are too low and barely perceptible by the pilot and air traffic control;
the aircraft being reconfigured far too early, leading to an increase in aerodynamic noise which then exceeds engine noise in the landing phases.

In addition, the use of the engines or air brakes also increases the aircraft's noise footprint on the ground, which is also undesirable in a context of increasing urbanization close to airports.

The presence of high-altitude altitude constraints, often combined with speed constraints, is a scenario that occurs more frequently with increasing traffic. This leads current systems to compute geometric segments up to very high altitudes, close to cruising level, strongly penalizing the efficiency of aircraft in the arrival phase.

Specifically, current flight management systems compute what is referred to as a geometric profile, i.e. a profile with a fixed slope to the bottom of the flight plan, as soon as a constraint incompatible with an idle regime is encountered, although it is theoretically possible to switch back to idle regime under the constraint in question.

The descent is then divided into two parts called the “geometric” descent and the “idle” descent.

The point of the flight plan separating the two types of descent (geometric and idle) is called the geometrical path point (GPP). The GPP is a point on the flight plan separating the geometric descent segment from the idle descent segment. It is generally determined by the first constraining altitude constraint. This means that from the start of the descent to the GPP, the predictions made in respect of the descent are made assuming idle (engine) thrust, and then the predictions are computed using slopes predicted so as to meet the constraining altitude constraints.

Reference may be made to patent FR 3 012 630 B1, which belongs to the Applicant, and which provides a method for constructing a vertical trajectory intended to optimize the manoeuvres of an aircraft in a phase of descent and approach towards a runway of an arrival airport, while maximizing the number and length of segments accomplished at reduced thrust able to be integrated into the procedure of descent and approach towards the landing point. This method has limitations; in particular, a distribution between dissipation of kinetic energy and dissipation of potential energy is not taken into account.

Thus, the limits of the known solutions are related to the fact that using the engines leads to an increase in fuel consumption and in emission of pollutants, and using the air brakes leads to an increase in the workload of the crew.

In addition, known solutions do not take into account the performance of the aircraft and the operational context of the aircraft, generating premature wear of the structure, and mechanistically increasing maintenance costs.

Thus, there is no flight management system allowing a “made-to-measure” energy dissipation profile that is tailored not only to the intrinsic performance of the aircraft, but also to the environmental conditions it encounters, to be computed during descent and approach phases.

### SUMMARY OF THE INVENTION

The present invention addresses this need.

One object of the invention is thus to mitigate the deficiencies of the prior art by providing a method for establishing, for descent and approach phases of an aircraft, an efficient energy-dissipation strategy, taking the form of a computation of an optimized 4D descent and approach path, which aims to maximize employment of the idle regime while minimizing use of air brakes via more effective deceleration.

Advantageously, the invention allows environmentally and economically sustainable flight procedures to be implemented in the descent and approach phases, such procedures having significant advantages in terms of fuel, emissions and noise.

Generally, the invention consists in computing and presenting to the crew an energy dissipation strategy intended to stabilize an aircraft at a certain altitude from its cruising level (1000 ft above ground level (AGL) for example), with explicit display of computation assumptions, so as to optimize descent and approach, in order to reduce crew workload and facilitate on-board decision making, and as a result simplify and streamline traffic management by ATC with a view to landing the aircraft.

In the context of so-called CDO flight procedures (CDO standing for Continuous Descent Operations) and green procedures (aiming to decrease noise pollution and pollutants), implementation of the method of the invention makes it possible to obtain an energy dissipation strategy that serves as a reference for automatic guidance of the aeroplane, in order to obtain all the expected benefits.

The method of the invention makes it possible to compute a 4D descent and approach path that is more efficient, because it takes into account the specific performance of the aircraft, and the context in which it is operating (current conditions, procedures and environment).

The computed 4D path provides the pilot with the best strategy to adopt depending on the state of the aircraft and on the current flight conditions, facilitating understanding on board.

The invention differs from the prior art in that it provides a new ability, making it possible to target the zones to be adjusted consistently with actual operations. Thus, the method of the invention makes it possible to determine zones that are said to be low energy and zones that are said to be high energy, in order to advantageously define the segments (i.e. slopes) that are to be decreased or increased.

Thus, in cases of low energy, a constant-speed adjustment makes it possible to obtain a set of segments that are sufficiently steep to meet the needs of air traffic control while avoiding using air brakes as currently required in such cases. Conversely, in cases of high energy, priority is given to using air brakes in decelerated segments, in order on the one hand to preserve an ability to respect a speed restriction originating from air traffic control on constant-speed segments via use of the air brakes, and on the other hand to reflect the operational practices of pilots, who prefer to use the air brakes to reduce aircraft speed rather than to maintain speed.

Advantageously, the method according to the invention makes it possible to adjust the distribution of energy dissipation between kinetic energy and potential energy.

Another advantage of the present invention lies in dividing working sections in a way that makes it possible to prevent processing of one section from generating in the neighbouring section a construction that is too gently sloped, or conversely too steep.

Advantageously, after the 4D path has been computed, all the elements required to understand the vertical strategy, which mainly allows the use of the engines and air brakes to be minimized and reduces deceleration lengths, are presented to the pilot (via HMIs—the ND, VD and MFD screens may be used) who then knows the actions required along the computed path, this increasing her or his understanding of the aircraft's energy situation and allowing her or him to better anticipate the optimal strategy to implement to dissipate its energy.

Advantageously, the flight management system is able to automatically adapt the proposed vertical strategy through optimal modification of the configuration of the aeroplane, and/or through modification of the speed strategy.

The invention may preferably be used in relation with a flight management system (FMS). It may be easily customized to various versions of flight management systems. It may also be implemented on a flight tablet external to a management system, i.e. in a non-avionics system, and coupled operationally to such a flight management system.

The invention is applicable in any computation of path and predictions that is present in an FMS or in any on-board or off-board navigation means managing the path of an aircraft (drone for example).

The invention may be generalized to any piloted aircraft, in flight or on the ground, equipped with a path management system.

To obtain the desired results, a computer-implemented method for managing energy to be dissipated for an aircraft during descent and approach phases is provided.

The method comprises steps executed in the course of a backward computation of predictions by a flight management system, when a waypoint is identified as an anchor point having altitude constraints but no slope constraints.

The steps of the method consist in:
determining an initial idle flight path at idle thrust, between an anchor point and the cruise flight level, and evaluating whether all altitude constraints are met for the idle flight path;
if at least one altitude constraint is not met, defining a working section between the anchor point and the waypoint where the altitude constraint is not met, and determining whether, in this section, there is both one or more decelerated flight segments and one or more constant-speed flight segments;
if there is at least one decelerated flight segment and at least one constant-speed flight segment:
   evaluating an energy delta to join the idle path; and
   constructing an optimized flight profile taking into account the evaluation, the optimized flight profile consisting, for said section, either in exclusively applying thrust or in exclusively using air brakes, while maximizing the distance travelled in idle.

The invention makes provision for a plurality of alternative or combinable embodiments.

According to one particular aspect of the invention, the evaluating step consists in determining whether the energy delta is negative or positive.

According to one particular aspect of the invention, the step of constructing an optimized flight profile consists in constructing a low-energy profile consisting in exclusively applying thrust if the energy delta is negative.

According to one particular aspect of the invention, the step of constructing an optimized flight profile consists in constructing a high-energy profile consisting in using exclusively the air brakes if the energy delta is positive.

According to one particular aspect of the invention, the step of constructing a flight profile consisting in exclusively applying air brakes comprises steps of determining an angle of the flight path, and of performing a segment-by-segment backward integration, until a verification condition indicative of the target constraint having been met is satisfied.

According to one particular aspect of the invention, the step of determining, in a working section, the decelerated flight segments and the constant-speed flight segments comprises a step of constructing a geometric flight profile if there is not, in said working section, both at least one decelerated flight segment and one constant-speed flight segment.

According to one particular aspect of the invention, the method comprises a step of determining whether the speed of the aircraft is being managed in selected mode and if so solely maintaining construction of a geometric flight profile.

According to one particular aspect of the invention, the method in addition comprises a step of displaying, on a cockpit display screen, the obtained path with an optimized flight profile.

According to one particular aspect of the invention, the method in addition comprises a step of defining a new anchor point.

The invention also relates to a device for managing energy to be dissipated for an aircraft during descent and approach phases, the device comprising means for implementing the steps of the method of the invention.

The invention also relates to an aircraft flight management system comprising a device according to the invention.

The invention also relates to a piece of non-avionics aircraft equipment comprising a device according to the invention.

The invention also relates to a computer program product comprising code instructions allowing the steps of the method of the invention to be performed, when said program is executed on a computer.

### BRIEF DESCRIPTION OF THE DRAWINGS

Other features and advantages of the present invention will become more clearly apparent on reading the description that follows with reference to the following drawings.

FIG. 1, which has already been described, schematically illustrates the structure and functions of a flight management system (FMS) making it possible to implement the device of the invention;

FIG. 2 schematically illustrates one example of implementation of the invention in an FMS;

FIG. 3 shows, in the form of a flowchart, the steps of the method of the invention, in one nominal embodiment;

FIG. 4 shows, in the form of a flowchart, one embodiment of the step of constructing a “low-energy” (LE) profile;

FIG. 5 shows, in the form of a flowchart, one embodiment of the step of constructing a “high-energy” (HE) profile;

FIG. 6 shows, in the form of a flowchart, one variant of embodiment of the steps of constructing a “high-energy” profile according to the method of the invention;

FIG. 7 illustrates slopes obtained by constructing an HE profile in one embodiment of the invention;

FIG. 8 illustrates the effect of the deceleration rate on altitude.

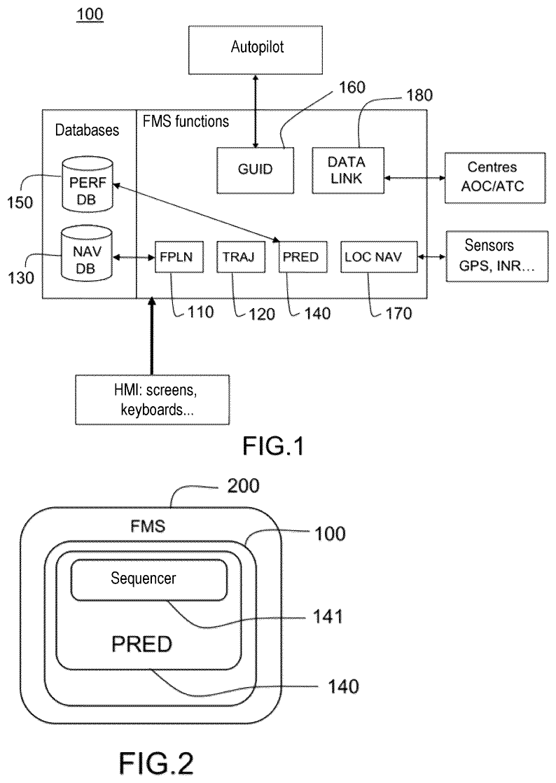

### DETAILED DESCRIPTION

In addition to the definitions given above, the meaning of a number of acronyms and expressions, which are either commonly employed in the aeronautical field, or which are used in the remainder of the description, will now be recalled.
FPA: flight path angle.
CSTR: constraint.
CRZ FL: cruise flight level.
CAS: calibrated air speed.
ISO CAS: constant calibrated air speed.
TSP: too steep path.
MDR: minimum deceleration rate.
AP: anchor point. An anchor point is defined as an altitude-constrained point beyond the final approach, which is identified in the course of a backward computation of predictions by a flight management system.
VS: vertical speed.
Backward: a mode of computation referred to as backward starts from an end point and proceeds backward to a start point.
Forward: a mode of computation referred to as forward starts from a start point and proceeds forward to an end point.
GEO: geometrical (for example a geometrical profile).
LE: low energy (for example a low-energy profile).
HE: high energy (for example a high-energy profile).
ΔE for energy delta: the difference in total (kinetic and/or potential) energy between the end point of an idle profile computed backward from an AP and a procedural constraint.

In one embodiment, which is illustrated in FIG. 2, the method of the invention is implemented by a sequencer 141 in a prediction module 140 of an FMS 100 or of a flight management system having a functional architecture comparable to an FMS, within an aircraft 200. Since the FMS is generally connected to many computers (several tens), some of them may be employed to implement one or more steps of the computation of a 4D descent and approach path according to the method of the invention.

In one embodiment, a “state machine” (or “finite-state machine”) may be used as sequencer 141. In digital electronics, a finite-state machine may be constructed using a programmable logic circuit, or a programmable logic controller, with logic functions performed by flip-flops or relays. A hardware implementation in general comprises a register for storing state variables, a combinational logic circuit that determines state transitions, and a combinational logic block that determines the outputs of the controller.

An avionics sequencer here defines a sequence of segments to be used/flown according to a computed strategy, i.e. defined by logic rules governing successions or sequences of segments. The resulting set of segments forms a vertical reference path to which the aircraft will be automatically controlled. Thus, an avionics sequencer assembles here, according to predefined rules, various path segments satisfying the flight plan, on the basis of an initial aeroplane state or of a predefined strategy related to the various guidance modes of the aircraft.

In one alternative embodiment, the method of the invention is implemented by a sequencer implemented on a piece of non-avionics equipment, such as a flight tablet or an electronic flight bag (EFB), that is operationally coupled to a flight management system. Generally, a tablet computer or a removable or portable screen located in the cockpit may be used.

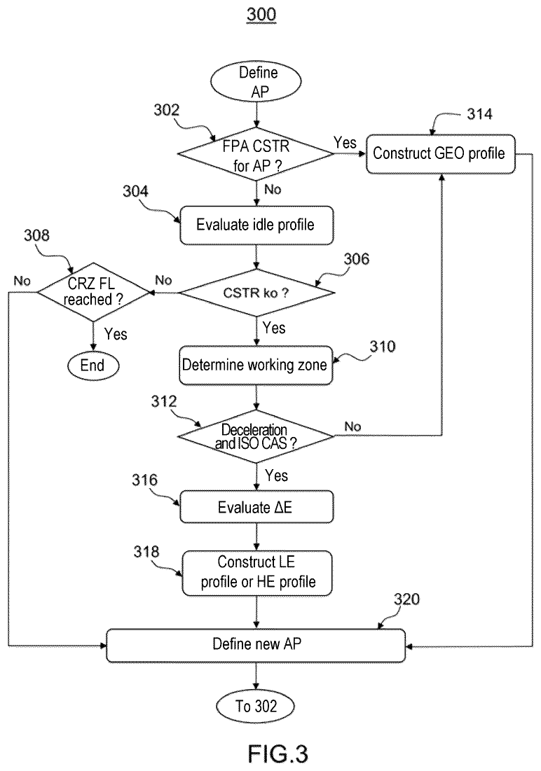

FIG. 3 shows, in the form of a flowchart, the steps of the method of the invention, in one nominal embodiment.

The method 300 is initialized in the course of a computation of predictions of the FMS, and more precisely during a backward profile computation, each time an altitude-constrained point beyond the final approach, or anchor point AP, is reached.

In a preliminary step 302, the method consists in verifying whether the anchor point is associated with a slope constraint.

If such is the case, it means that there is no degree of freedom, and the method makes it possible to construct 314 a GEO profile to the end of applicability of the slope constraint.

If the anchor point is not associated with a slope constraint, the method continues with a step 304 allowing an evaluation, assuming no altitude constraint, of an optimized initial path (the idle path) for an idle profile, i.e. a profile with the engines idling. The initial idle path contains decelerated and constant-speed flight segments.

In one embodiment, the method 300 is applied only in the case where speed is being managed in managed mode, and comprises a step of determining whether the speed of the aircraft is being managed in selected mode or in managed mode.

In the case where speed is already being managed in selected mode or selected mode is switched to, the method is applied or is reapplied using an approach based on automatic construction of a geometric flight profile in step 314.

After step 304, the method, in a following step 306, makes it possible to evaluate whether all the altitude constraints have been met by the initial idle path, and therefore to determine whether at least one of the altitude constraints between the current flight point and the anchor point has not been met.

If all the altitude constraints have been met (branch No), the method makes it possible in a step 308 to verify whether the cruising level has been reached with the idle profile.

If the cruising level has been reached, the construction of the “idle” profile is retained and the method ends (branch Yes).

If the cruising level has not been reached with the idle profile, the method makes it possible to loop to a new anchor point (step 320) and start again with the preliminary step 302.

Returning to step 306, if at least one of the altitude constraints has not been met by the optimized idle path (branch Yes), the method makes it possible, in a following step 310, to define a computational section or working zone between the current anchor point and the waypoint where the altitude constraint would be missed.

In one embodiment, the working zone may be adjusted to avoid segments of excessively gentle slope, or conversely to avoid excessively steep segments.

Once the working zone has been defined, the method makes it possible, in a following step 312, to determine whether there are, in this zone, both decelerated flight segments and constant-speed flight segments.

If decelerated flight segments and constant-speed flight segments do not coexist on the working zone, the method makes it possible (branch No) in a following step 314 to construct a GEO profile.

If, in the working zone, it is determined that both at least one decelerated flight segment and at least one constant-speed flight segment exist, the method makes it possible (branch Yes), in a following step 316, to carry out an evaluation of the energy delta required to reach the idle path from the constrained waypoint, in order to verify which energy dissipation strategy may be implemented in the working zone.

The evaluation of the energy delta makes it possible to construct a flight profile for the working section, which takes into account the result of the evaluation. The flight profile may consist, for the section in question, either in following gentler slopes, which will lead to thrust being applied, or in using the air brakes to follow steeper slopes.

In one embodiment, corresponding to the present description of an example given to facilitate comprehension of the principles of the invention, the method is implemented considering solely potential energy E_{P} and the evaluation is carried out in respect of the potential-energy delta ΔE=ΔE_{P}.

However, this example is non-limiting, and the method may be applied to kinetic energy E_{C} and an evaluation of the kinetic-energy delta ΔE=ΔE_{C}.

In one variant of embodiment, the method may be applied to carry out an evaluation of the total-energy delta, i.e. the delta of the total potential and kinetic energy ΔE=ΔE_{P}+ΔE_{C}.

After step 316 of evaluating the remaining energy, the method makes it possible, in a following step 318, to construct a specific flight profile allowing suitable energy dissipation, depending on the result of the evaluation, the flight profile potentially being an LE profile, i.e. a profile said to be low-energy, or an HE profile, i.e. a profile said to be high-energy.

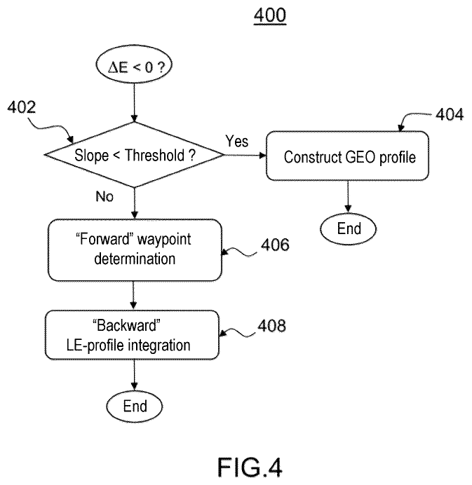

If the evaluation indicates that the potential-energy delta is negative (i.e. the missed constraint is below the flight path provided by the initial idle profile), the method makes it possible to construct an LE profile. The LE profile allows constant-speed segments to be lowered while keeping them at a sufficient level, i.e. thrust or energy to be applied without slope being too gentle. FIG. 4 illustrates one embodiment of the steps allowing an LE profile to be constructed.

If the evaluation indicates that the potential-energy delta is positive (i.e. the missed constraint is above the flight path provided by the initial idle profile), the method makes it possible to construct an HE profile. The HE profile allows deceleration segments to be increased first and foremost before raising the constant-speed segments, i.e. the air brakes to be put on because there is too much energy.

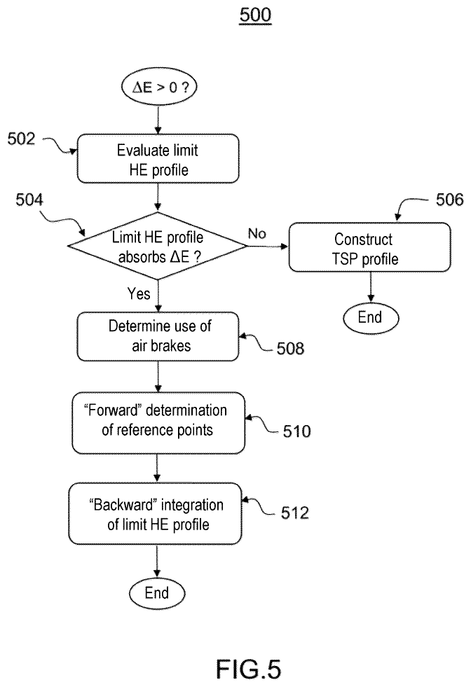

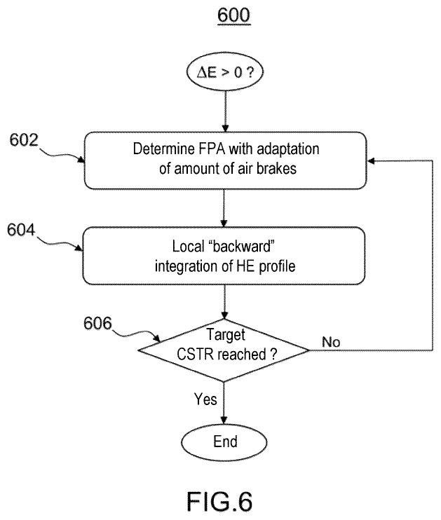

FIGS. 5 and 6 illustrate two variants of construction of an HE profile.

Step 318 of constructing an LE or HE profile makes it possible to provide a reference profile between the anchor point and the waypoint of the targeted missed constraint.

After the step of constructing the LE or HE profile, the method makes it possible to loop 320 to a next anchor point, which will be the point representing the next target constraint.

The method of the invention may be implemented in the form of a program comprising non-transient code instructions which, when the program is executed by a processor, lead the processor to execute the described steps of the method for computing a 4D descent and approach according to the invention.

FIG. 4 shows, in the form of a flowchart, steps of constructing an LE profile, in one embodiment of the method of the invention.

This is a situation when the target point detected by the idle evaluation is a missed constraint that is located below the optimized idle path. The resulting profile is then a low-energy profile. Consequently, the objective of the optimized path is, on the one hand, to avoid use of the air brakes, and on the other hand, to limit as much as possible use of thrust without generating segments having excessively gentle slopes.

The provided solution in the variant of FIG. 4 consists in maintaining for as long as possible the idle regime from the anchor point in order to minimize fuel consumption and low-altitude noise.

Furthermore, on the part modified to satisfy the target point, the provided solution consists in any deceleration being carried out on a set of slopes equivalent to the slope of the idle regime, while avoiding segments that are too gently sloped (i.e. that have a slope gentler than the slope equivalent to the idle regime).

The method makes it possible to carry out a verification, in 402, to evaluate whether the resulting geometric slope in the working zone is too gentle.

If the slope is too gentle (branch Yes), the method makes it possible, in a following step 404, to construct a GEO flight profile, in order to avoid segments of excessively gentle slope that could cause pilots and air traffic controllers difficulties due to descent rates being too low in operation, and lead to excessive excursions contrary to standards in force.

If the slope is sufficiently steep (branch No), the method makes it possible to carry out an evaluation, in 406, in order to determine, in forward computation mode, from the high point of the working section, a meeting point among the points established in the idle profile during the initial idle evaluation in 304, and any waypoints. The selected meeting point meets the objective of minimizing the geometrical parts, while maximizing the parts flown in idle regime without applying additional thrust.

The method continues with a step 408 of, based on the initial idle evaluation and on the selected meeting point, integrating a profile in backward mode, from the anchor point to the target point, the profile being characterized by an idle regime to the meeting point, then a geometrical construction between the meeting point and the target point. In this way, deceleration slopes are maintained and constant-speed slopes are adapted to absorb the required energy delta.

The algorithm for constructing an LE profile ends and loops to step 320 of the general method.

FIG. 5 shows, in the form of a flowchart, steps of constructing an HE profile, in a first embodiment of the method of the invention.

This is a situation when the target point detected by the idle evaluation is a missed constraint that is located above the optimal idle path. The resulting profile is then a high-energy profile, and the use of air brakes is necessary to follow it.

The aim of the optimized path is then to use an idle thrust along the entire length of the path while limiting as much as possible use of the air brakes to the decelerating parts, before extending it to the constant-speed segments.

Advantageously, maintaining the engine speed at idle for as long as possible from the anchor point minimizes noise and fuel consumption at low altitudes, while minimizing use of the air brakes.

Another advantage of this HE construction is to ensure, as much as possible, an ability to absorb a deceleration along the entire length of the profile (for example an ATC speed limitation).

Thus, the solution is that the air brakes are first applied gradually in the deceleration segments, in such a way as to guarantee a minimum deceleration rate and that no deceleration will cause the aircraft to dive.

In the case where more drag is necessary, the air brakes are gradually applied in the constant-speed segments.

When intensifying all the deceleration segments is insufficient, the air brakes are gradually applied in the constant-speed segments.

According to various embodiments, the air brakes are applied either from the upper parts to the lower parts, or from the lower parts to the upper parts.

Returning to FIG. 5, if the evaluation indicates that the potential-energy delta is positive, the method makes it possible, in a first step 502, to construct an evaluation of a maximized high-energy profile (i.e. the most aggressive high-energy profile possible) with an idle profile having the maximum permitted rate of air-brake application, 50% for example.

This construction remains limited by any constraining intermediate altitude constraints that must be met.

In a following step 504, the method makes it possible to determine whether or not this profile makes it possible to absorb the energy delta to be absorbed.

If this max HE profile does not make this possible (branch No), the method makes it possible, in 506, to construct a TSP profile (TSP standing for Too Steep Path) which is made up of an assembly of the max HE profile, and of a vertical discontinuity at the distance to the destination of the end constraint of the working section.

This profile makes it possible, theoretically, to absorb the residual energy delta. This construction is particularly suitable in cases of discontinuities in the flight plan in the lateral plane, distorting the length of the path and consequently the resulting slopes in the vertical plane.

If the max HE profile makes it possible to absorb more energy than the delta energy to be absorbed (branch Yes), the method makes it possible, in a following step 508, to determine whether air brakes will be necessary in one or more decelerated segments, and optionally in one or more constant-speed segments, the objective still being to join the initial idle evaluation.

Next, the method continues with a step 510 making it possible to determine, in forward computation mode, intermediate waypoints called reference points, based on the data obtained in the preceding step and on data characterizing the performance of the aircraft.

These points are then targeted by an integration of the profile from the anchor point to the targeted end point so as to naturally apply air brakes in the desired segments.

The method continues with a step 512 of integrating a profile in backward mode, from the anchor point to the target point, the profile making it possible to apply air brakes in the decelerated segments first and foremost, then to apply them in the constant-speed segments.

According to various embodiments, the air brakes are applied either from the upper parts to the lower parts, or from the lower parts to the upper parts.

The algorithm for constructing an HE profile ends and loops to step 320 of the general method.

FIG. 6 shows, in the form of a flowchart, one variant of embodiment of the steps of constructing an HE profile according to the method of the invention.

This variant offers a simpler algorithm for computing HE profile, in particular from the point of view of computing performance and software complexity. It allows CPU impact to be reduced without significantly decreasing the operational benefits.

It is generally a question of determining, in 602, an angle of the flight path FPA, then of carrying out, in 604, a backward integration segment by segment, until a verification condition indicative of the target constraint having been met is satisfied, in 606.

The backward segment-by-segment computation guarantees that the path remains flyable locally with the maximum permitted rate of air-brake application and a minimum rate of deceleration when so required.

To this end, for each segment, the average slope leading to the target constraint is compared to the flyable maximum slope, and the most constraining slope is retained while guaranteeing sufficient use of the air brakes to avoid undue TSPs.

This variant consists in integrating the profile backward piecewise, from the last point obtained from the initial idle evaluation, which is located above the geometric slope between the anchor point and the target constraint, to the target constraint.

Each piece of integration corresponds to a set geometric ground slope contained in a cone.

In one embodiment, a high bound of the cone is defined by what the aeroplane is capable of flying with a maximum extension of the air brakes (either on a deceleration segment with a target rate, or on a constant-speed segment) and a low bound of the cone is defined by the geometric slope between the start point of integration and the target constraint, itself limited by the idle slope (so as not to induce application of thrust or undue TSPs).

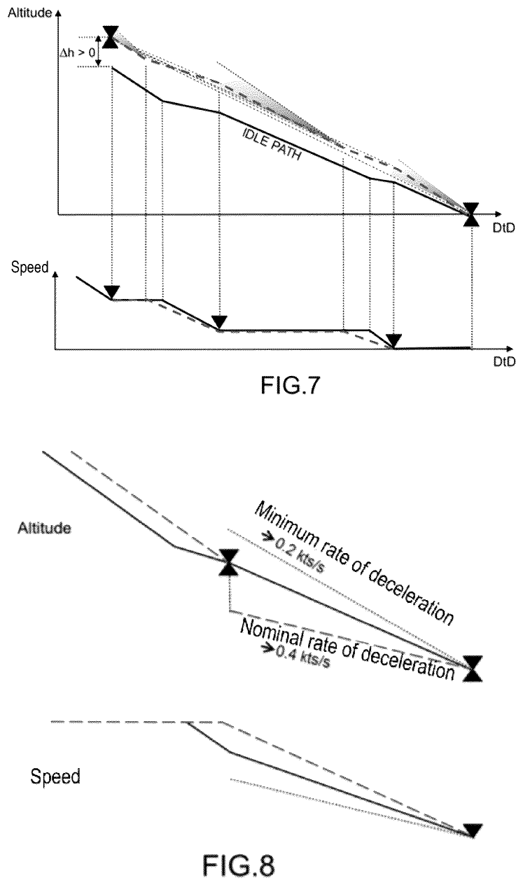

FIG. 7 illustrates construction of an HE profile according to this variant, showing the geometric slope between the current integration point and the target constraint, and the steepest slope flyable by the aeroplane considering maximum extension of the air brakes.

In order to use just the amount of air brakes required to minimize application of thrust while avoiding the creation of TSPs, the percentage of air-brake application may be defined via estimations based on geometric or energy methods, while considering the abilities of the aircraft, which are known from its performance database.

This mechanism is repeated until the high target constraint is reached, with a discretization that is given by stop points that may vary depending on the chosen embodiment.

This type of construction has the advantage of being generic and applicable to the portions called HE portions and to the portions called TSP portions.

In order to limit the number of TSPs, which include by definition a vertical discontinuity having operational impacts and a negative impact on the workload of pilots in particular, the target deceleration rate in decelerated segments is automatically reduced, this allowing ground slope to be increased by decreasing the deceleration rate.

The construction referred to as TSP corresponds to the highest profile and is induced by any altitude constraint that requires being above this pathway. This profile causes a maximum rate of air-brake application in the decelerations and the constant-speed parts, and ends with a vertical discontinuity when it reaches the distance of the constraining constraint. If the resulting altitude profile is therefore discontinuous, the speed profile for its part remains continuous, even when “crossing” the vertical discontinuity.

To allow the pilot to anticipate this type of discontinuity, a marker is displayed in the cockpit, on the flight-plan page, in the place where the discontinuity is generated. When the discontinuity is reached, the system may ask the pilot to extend the air brakes if necessary, and automatically adapt the guidance modes to promote reconvergence.

Presentation in the cockpit of the path thus obtained, automatic guidance on this path, and explicit presentation of the computation assumptions used (change of speed and actuator), through suitable symbology, allow the pilot(s) to optimize the path while guaranteeing stabilization of the aircraft at 1000 ft AGL.

Thus, providing different slopes for the parts flown at constant speed and the decelerated parts makes it possible to improve the dissipation of kinetic energy, which is currently problematic, while decreasing use of the engines and air brakes.

FIG. 8 is an illustration of the effect of the deceleration rate on altitude.

In one variant of embodiment, still with the aim of not creating undue TSPs, local use of the air brakes in decelerated and/or constant-speed segments, if it is estimated that the altitude delta to be compensated requires it, may, for example, be based on one of the following methods (non-exhaustive list):
numerical integration to the target constraint;
an estimation of all the slopes successively applicable with regard to the energy delta to be absorbed;
an overall energy estimation considering the total energy of the aircraft.

In summary, the present invention makes it possible:
to define a made-to-measure descent path that is optimized and non-geometrical with regard to the performance of the aeroplane and the context in which it is operating (meteorological conditions and flight plan) allowing use of the engines and air brakes to be decreased, and therefore ultimately a more efficient energy dissipation strategy to be obtained;
to implement specific logic tailored to low-energy and high-energy situations depending on scenario typology;
to display context information and actions to be carried out by the pilot to satisfy the optimized strategy.

The advantages of the invention are thus:
a decrease in use of the engines;
a decrease in use of the air brakes;
better anticipation and comprehension by the pilot of the actions to be taken to efficiently dissipate energy depending on the situation encountered;
facilitation of ground/on-board exchange;
increased traffic fluidity.

1. A computer-implemented method for managing energy to be dissipated for an aircraft during descent and approach phases, the method comprising steps executed in the course of a backward computation of predictions by a flight management system, when a waypoint is identified as an anchor point having altitude constraints but no slope constraints, the steps consisting in:
determining an initial idle flight path at idle thrust, between an anchor point and the cruise flight level, and evaluating whether all altitude constraints are met for the idle flight path;
if at least one altitude constraint is not met, defining a working section between the anchor point and the waypoint where the altitude constraint is not met, and determining whether, in this section, there is both one or more decelerated flight segments and one or more constant-speed flight segments;
if there is at least one decelerated flight segment and at least one constant-speed flight segment:
evaluating an energy delta to join the idle path; and
constructing an optimized flight profile taking into account the evaluation, the optimized flight profile consisting, for said section, either in exclusively applying thrust or in exclusively using air brakes, while maximizing the distance travelled in idle.

2. The method according to claim 1, wherein the evaluating step consists in determining whether the energy delta is negative or positive.

3. The method according to claim 2, wherein the step of constructing an optimized flight profile consists in constructing a low-energy profile consisting in exclusively applying thrust if the energy delta is negative.

4. The method according to claim 2, wherein the step of constructing an optimized flight profile consists in constructing a high-energy profile consisting in using exclusively the air brakes if the energy delta is positive.

5. The method according to claim 1, wherein the step of constructing a flight profile consisting in exclusively applying air brakes comprises steps of determining an angle of the flight path, and of performing a segment-by-segment backward integration, until a verification condition indicative of the target constraint having been met is satisfied.

6. The method according to claim 1, wherein the step of determining, in a working section, the decelerated flight segments and the constant-speed flight segments comprises a step of constructing a geometric flight profile if there is not, in said working section, both at least one decelerated flight segment and one constant-speed flight segment.

7. The method according to claim 1, comprising a step of determining whether the speed of the aircraft is being managed in selected mode and if so solely maintaining construction of a geometric flight profile.

8. The method according to claim 1, in addition comprising a step of displaying, on a cockpit display screen, the obtained path with an optimized flight profile.

9. The method according to claim 1, in addition comprising a step of defining a new anchor point.

10. A computer program product comprising code instructions allowing the steps of the method according to claim 1 to be performed, when said program is executed on a computer.

11. A device for managing energy to be dissipated for an aircraft during descent and approach phases, the device comprising means for implementing the steps of the method of claim 1.

12. An aircraft flight management system comprising a device according to claim 11.

13. A piece of non-avionics aircraft equipment comprising a device according to claim 11.
